(19) United States
(12) Patent Application Publication
(10) Pub. No.: US 2025/0347778 A1
(43) Pub. Date: Nov. 13, 2025

(54) ADJUSTABLE SENSOR SYSTEM FOR A VEHICLE

(71) Applicant: Oshkosh Corporation, Oshkosh, WI (US)

(72) Inventor: Guido Ritelli, Oshkosh, WI (US)

(73) Assignee: Oshkosh Corporation, Oshkosh, WI (US)

(21) Appl. No.: 19/087,249

(22) Filed: Mar. 21, 2025

Related U.S. Application Data
(60) Provisional application No. 63/643,631, filed on May 7, 2024.
(60) Provisional application No. 63/643,788, filed on May 7, 2024.
(60) Provisional application No. 63/643,627, filed on May 7, 2024.
(60) Provisional application No. 63/643,541, filed on May 7, 2024.
(60) Provisional application No. 63/643,723, filed on May 7, 2024.
(60) Provisional application No. 63/643,653, filed on May 7, 2024.
(60) Provisional application No. 63/643,617, filed on May 7, 2024.
(60) Provisional application No. 63/643,608, filed on May 7, 2024.
(60) Provisional application No. 63/643,528, filed on May 7, 2024.
(60) Provisional application No. 63/712,602, filed on Oct. 28, 2024.
(60) Provisional application No. 63/713,023, filed on Oct. 28, 2024.
(60) Provisional application No. 63/712,662, filed on Oct. 28, 2024.
(60) Provisional application No. 63/712,621, filed on Oct. 28, 2024.
(60) Provisional application No. 63/712,647, filed on Oct. 28, 2024.
(60) Provisional application No. 63/741,768, filed on Jan. 3, 2025.
(60) Provisional application No. 63/741,710, filed on Jan. 3, 2025.
(60) Provisional application No. 63/775,273, filed on Mar. 20, 2025.

(51) Int. Cl. G01S 7/481; G01S 17/931

(52) U.S. Cl. CPC G01S 7/4811; G01S 17/931

(57) ABSTRACT

An autonomous vehicle system includes a vehicle and a sensor movably coupled with the vehicle. An actuator is configured to move the sensor to reposition the sensor on the vehicle. A controller is configured to detect an obstruction of the sensor and operate the actuator to reposition the sensor.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (1) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

One exemplary embodiment relates to an autonomous vehicle system. The autonomous vehicle system includes a vehicle and a sensor movably coupled with the vehicle. An actuator is configured to move the sensor to reposition the sensor on the vehicle. A controller is configured to detect an obstruction of the sensor and operate the actuator to reposition the sensor.

Another exemplary embodiment relates to a vehicle. The vehicle includes a frame, an interface assembly configured to support a product, and a sensor coupled to the frame and configured to sense an environment around the vehicle. A controller is communicably coupled to the sensor. The controller is configured to receive a signal from the sensor, detect an obstruction in a field of view of the sensor based on the signal, determine a corrective action to compensate for the obstruction and control an actuator or adjust operation of the sensor to perform the corrective action.

Additionally, an exemplary embodiment relates to a method of manufacturing a vehicle. The method may include providing a frame and coupling an interface assembly configured to support a product to the frame. The method may also include coupling a sensor to the frame, the sensor configured to sense an environment around the vehicle, and communicably coupling a controller to the sensor. The controller may be configured to receive a signal from the sensor, detect an obstruction in a field of view of the sensor based on the signal, determine a corrective action to compensate for the obstruction, and control an actuator or adjust operation of the sensor to perform the corrective action.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a top view of the vehicle of FIG. 1 including a sensing system, according to an exemplary embodiment.

FIG. 10 is a perspective partial view the sensing system of FIG. 9, according to an exemplary embodiment.

FIG. 11 is a top view of a sensing field of the sensing system of FIG. 9, according to an exemplary embodiment.

FIG. 12 is a perspective view of the sensing field of FIG. 11, according to an exemplary embodiment.

FIG. 13 is a top view of a sensing system of the vehicle of FIG. 1, according to an exemplary embodiment.

FIG. 14 is a side perspective view of the vehicle of FIG. 1 interfacing with another vehicle and supporting a component, according to an exemplary embodiment.

FIG. 15 is a side perspective view of the vehicle of FIG. 1, including a skate assembly, according to an exemplary embodiment.

FIG. 16 is a top view of a vehicle according to an exemplary embodiment.

FIG. 17 is a detail view of the vehicle of FIG. 16, according to an exemplary embodiment.

FIG. 18 is a front perspective view of the vehicle of FIG. 16, according to an exemplary embodiment.

FIG. 19 is a detail view of the vehicle of FIG. 16, according to an exemplary embodiment.

FIG. 20 is a bottom perspective view of the vehicle of FIG. 16, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, an autonomous vehicle includes one or more sensors for sensing the environment around the vehicle. The vehicle may support a product through various stages of assembly along an assembly line. In some embodiments, the product may obscure one or more sensors of the vehicle. To compensate for the field of view of the one or more sensors, the vehicle may adjust a position of the one or more sensors on the vehicle. In some embodiments, the vehicle preemptively moves/repositions the one or more sensors prior to the obstruction. For example, the vehicle may track the current stage of assembly for the product and include predetermined information regarding the position of the product relative to the vehicle at each stage. Prior to the product being positioned to obscure a sensor, the vehicle can adjust the sensor position to ensure the sensor field of view is not compromised, or to at least reduce the obstruction caused by the product. The sensor may be moved automatically to a predetermined position or may be moved until the sensor determines that the obstruction is reduced. The position of the sensor may be monitored by a second sensor to confirm the first sensor position and relocation, if necessary. In some embodiments, the vehicle may additionally and/or alternatively adjust an output of the sensor to compensate for the obstruction or the stage of assembly. In some embodiments, the vehicle may simply disable or temporarily inactivate or otherwise ignore the signal from one or more sensors the vehicle determines are obstructed. In some embodiments, the vehicle may additionally activate a secondary sensor to replace the sensor which was deactivate. The secondary sensor may be positioned in a position which is less obstructed by the product than the first sensor. The vehicle is therefore configured to detect an obstruction of one or more of the one or more sensors coupled to the vehicle, determine a corrective action, and automatically perform the corrective action to compensate for the obstructed sensor.

### Overall Vehicle

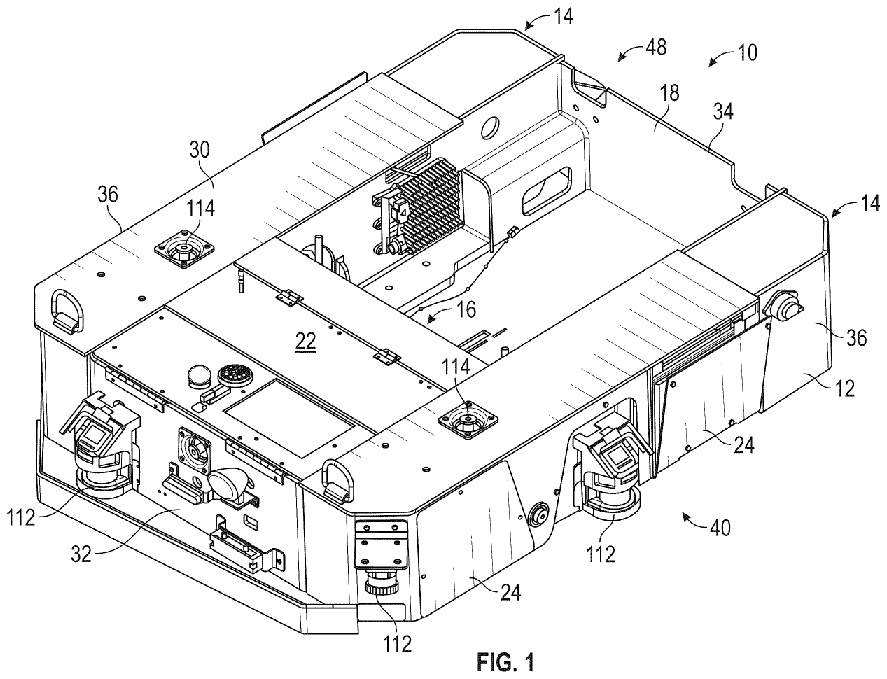

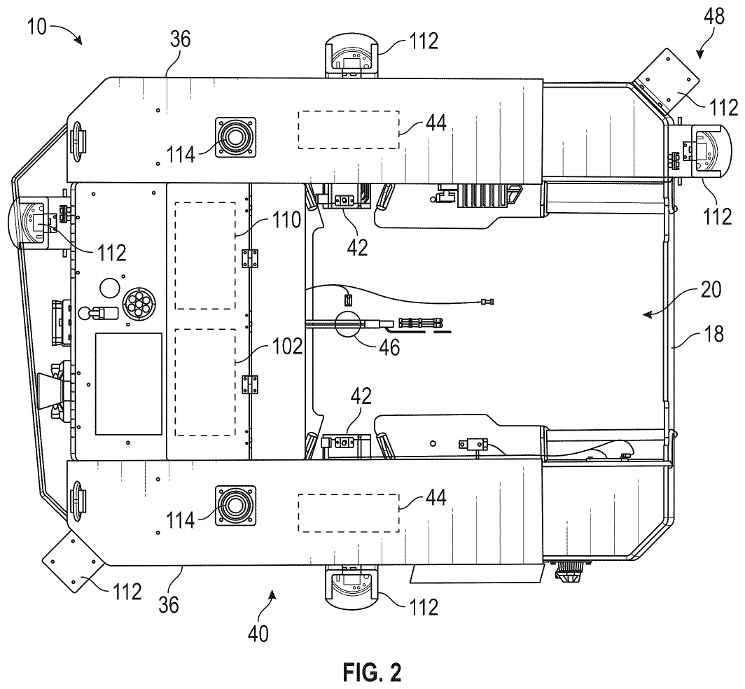

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 40 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

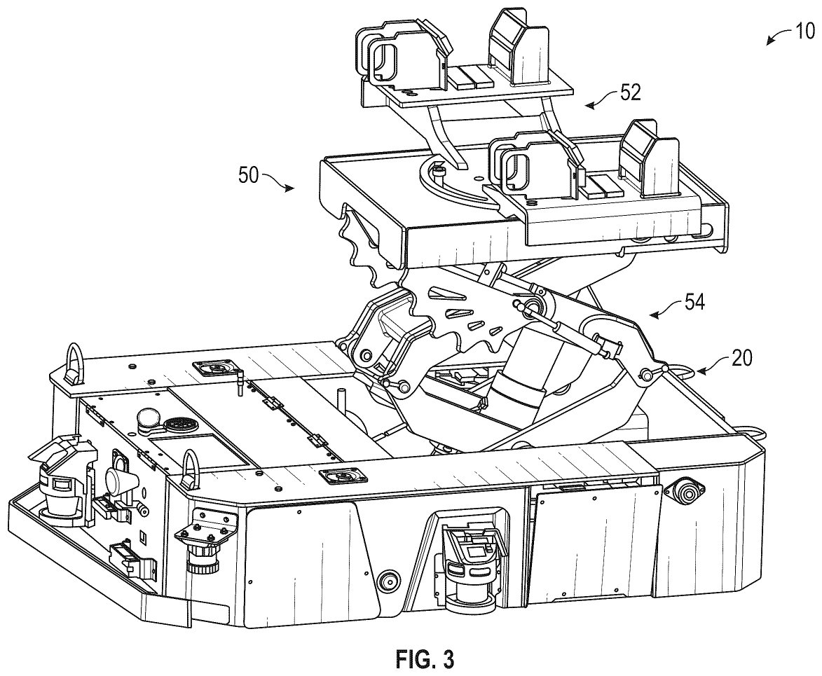

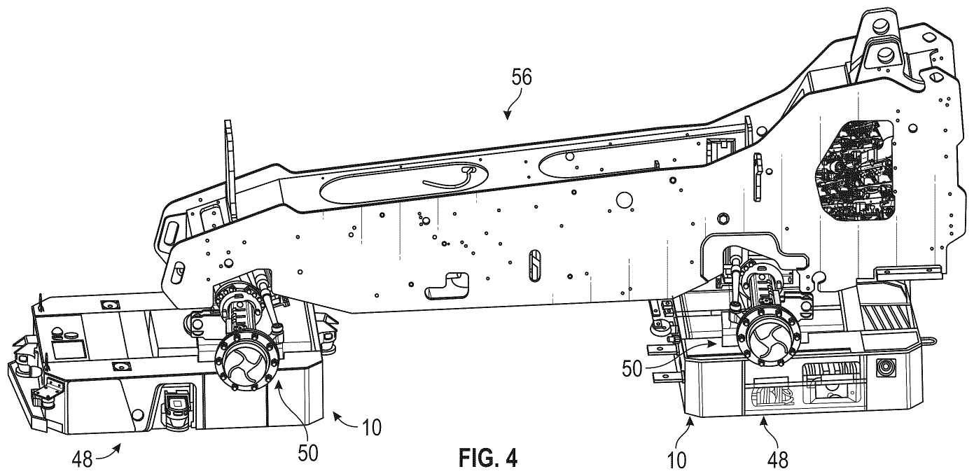

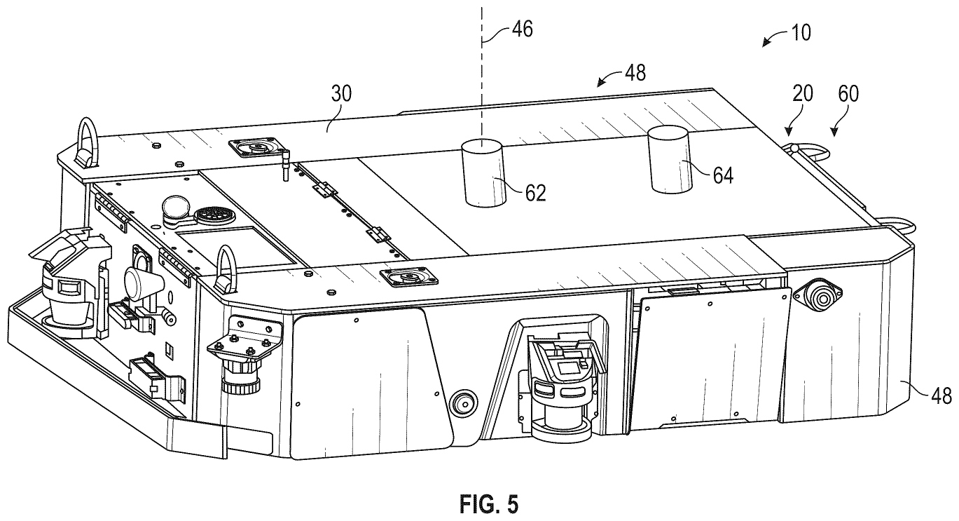

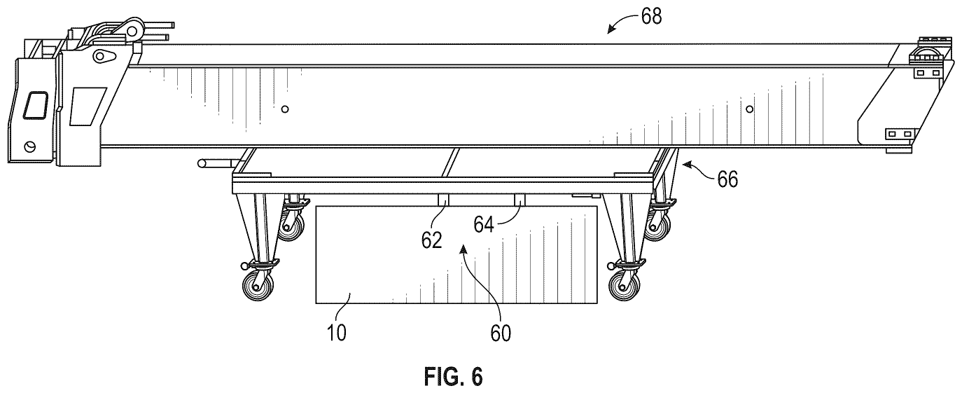

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

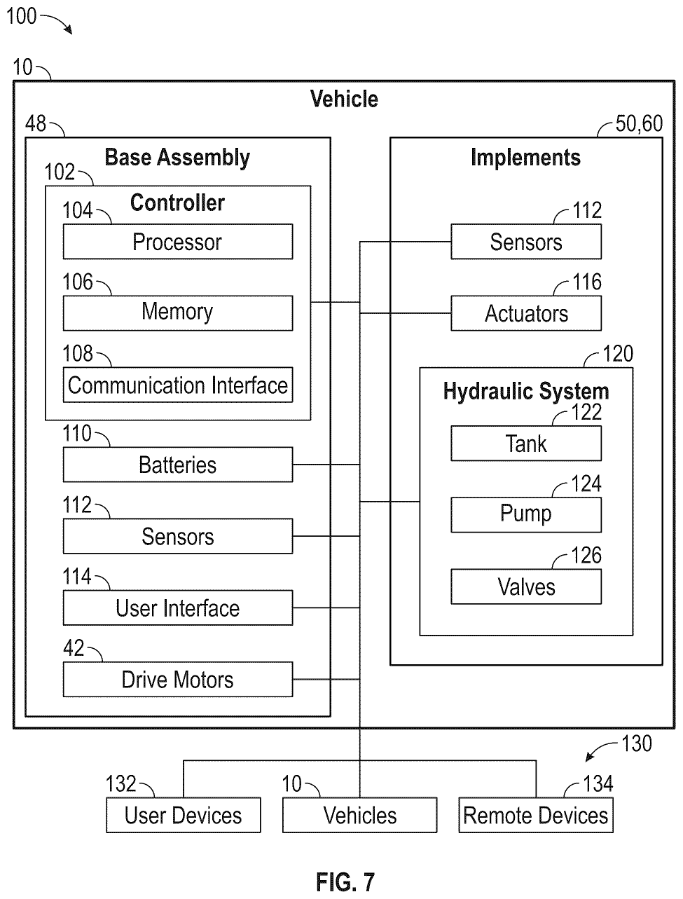

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. The hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system 100 may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

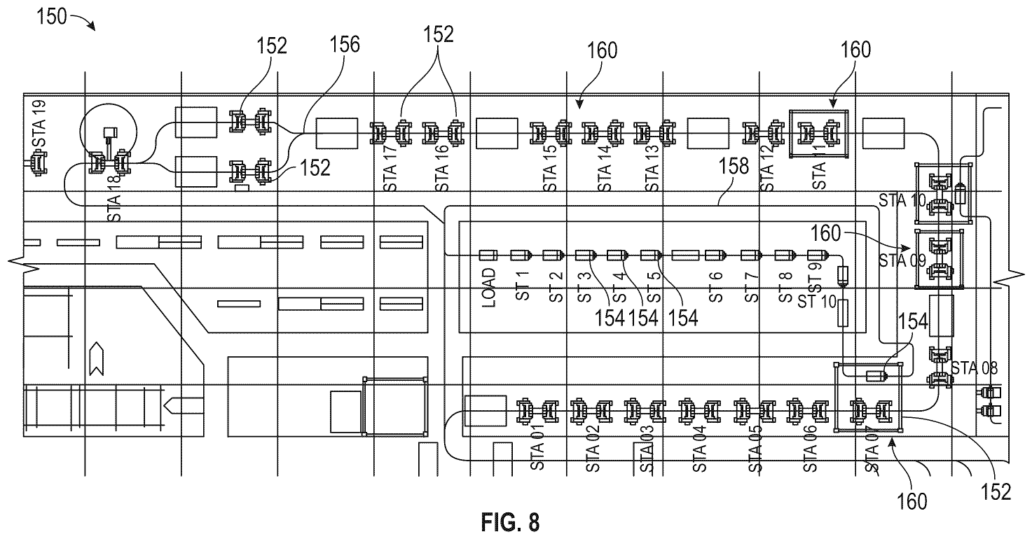

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

Sensing System and Sensor Configuration The sensors 112 of the vehicle 10 may facilitate autonomous navigation of the vehicle 10 throughout the manufacturing environment without the need for guide wires or other physical guiding devices, dedicated travel lanes, floor markings, etc. The sensors 112 may operate at a distance from any potentially sensed object, and no contact is required between the sensors 112 and an object to be sensed.

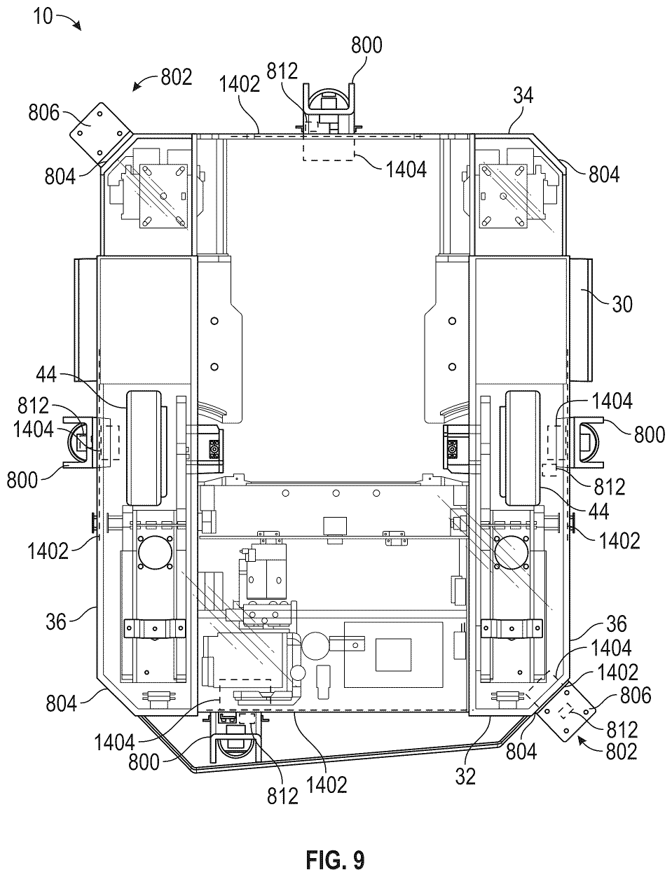

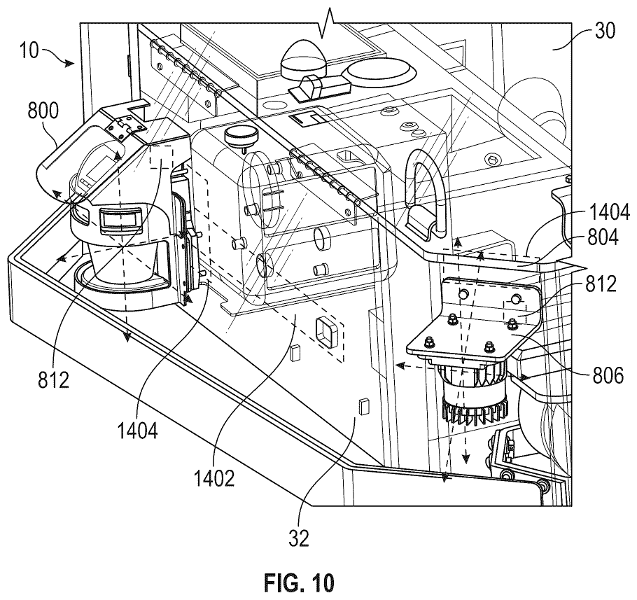

Turning now to FIGS. 9 and 10, the sensors 112 include short-range sensors 800 and long-range sensors 802 positioned around the exterior or perimeter of body of the vehicle 10. Each of the sensors 800 and sensors 802 may be movable coupled to the vehicle 10, such that the position of the sensor 800, 802 can be adjusted (e.g., manually, automatically) in response to one or more events such as an obstruction in a sensor 800, 802 field of view. According to an exemplary embodiment, the sensors 112 include one or more sensors 112 positioned about the frame 12, the drive modules 14, the controls enclosure 16, the back plate 18, and/or any other component of the vehicle 10 to acquire information or data relating to the operation of the vehicle 10 and the one or more components thereof. The sensors 112 may include any type of distance, proximity, image, and/or object sensors, such as one or more light curtain sensors, ultrasonic sensors, laser sensors, visible light cameras, full-spectrum cameras, light detection and ranging (LIDAR) cameras/sensors, radar sensors, infrared cameras, image sensors (e.g., charged-coupled device (CCD), complementary metal oxide semiconductor (CMOS) sensors, etc.), or any other type of suitable distance sensor, proximity sensor, or imaging device. In some embodiments, short-range sensors 800 are light curtain sensors, and the long-range sensors 802 are LIDAR sensors. In other embodiments, the short-range sensors 800 are ultrasonic sensors.

Data captured by or acquired using the short-range sensors 800 and the long-range sensors 802 may include, for example, data that may be used (e.g., by the controller 102) to determine a proximity of the vehicle 10 or any component of the vehicle 10 to an object (e.g., an obstacle, a wall, a person, etc.) while the vehicle 10 is stationary or in motion. By way of another example, data captured by the short-range sensors 800 and the long-range sensors 802 may include data that may be used to detect objects near or around the vehicle 10 or any component of the vehicle 10. In some embodiments, the data captured by the short-range sensors 800 and the long-range sensors 802 may be used to determine a state in which the vehicle 10 and/or any component of the vehicle 10 are operating. By way of example, the short-range sensors 800 and the long-range sensors 802 may be configured to acquire data to facilitate monitoring operation of the actuators 116, and such data may be used to determine whether the lift assembly 54 is in an extended position, a retracted position, any other position therebetween, and/or whether the lift assembly 54 is in the process of extending or retracting. By way of another example, the short-range sensors 800 and the long-range sensors 802 may be configured to acquire data to facilitate monitoring an orientation of the lift assembly 54 including a decline or depression angle, a rotation angle, and/or incline angle of the lift assembly 54.

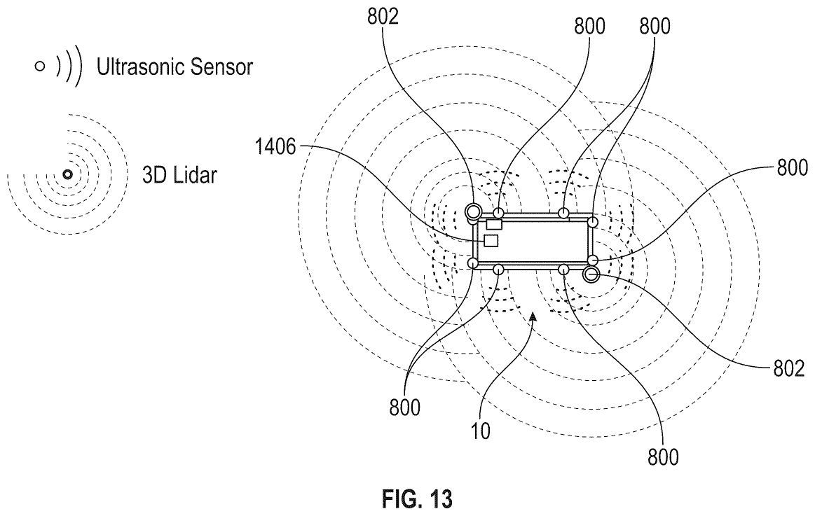

In the embodiment of FIG. 9, four of the short-range sensors 800 are shown positioned around the vehicle 10. Specifically, a first short-range sensor 800 is positioned along a front side of the vehicle 10 (e.g., the front surface 32). This short-range sensor 800 is laterally offset from a longitudinal centerline of the vehicle 10. A second short-range sensor 800 is positioned along a rear side of the vehicle 10 (e.g., the rear surface 34). This short-range sensor 800 is substantially laterally centered on the vehicle 10 (e.g., positioned along the longitudinal centerline). A third short-range sensor 800 is positioned along a left side of the vehicle 10 (e.g., a side surface 36), and a fourth short-range sensor 800 is positioned along a right side of the vehicle 10 (e.g., a side surface 36). The third and fourth short-range sensors 800 may be substantially longitudinally centered on the vehicle 10. This arrangement may permit the short-range sensors 800 to monitor the entire area surrounding the vehicle 10 (e.g., providing 360-degree coverage without any blind spots). FIG. 13 illustrates an alternative embodiment including eight of the short-range sensors 800.

The short-range sensors 800 may be considered secondary sensors to the long-range sensors 802, discussed further herein. The four short-range sensors 800 are each positioned on front, rear, left, and right sides of the vehicle 10. The short-range sensors 800 are oriented to perform sensing operations for areas in front of the vehicle 10, behind the vehicle 10, and/or to the sides of the vehicle 10. In other embodiments, fewer or more than four of the short-range sensors 800 may be included and/or the short-range sensors 800 may positioned or oriented differently. For example, the vehicle 10 may have eight of the short-range sensors 800, with two of the short-range sensors 800 positioned on each of the front, rear, left, and right sides of the vehicle.

In some embodiments, the short-range sensors 800 are light curtain sensors. The light curtain sensors may use an array of photoelectric beams to detect intrusion into a space (e.g., a sensing field, a plane, a curtain, etc.). An intrusion may be detected when an object interrupts one or more of the photoelectric beams within the sensing field. When an intrusion is detected, the light curtain sensors may send a signal (e.g., to the control system 100, etc.) to limit (e.g., cease) operations of the vehicle 10.

In some embodiments, the short-range sensors 800 are ultrasonic sensors. The ultrasonic sensors may use a transducer to send and receive ultrasonic pulses (e.g., sound waves, etc.) that relay information back to the ultrasonic sensor regarding the proximity of an object. The ultrasonic sensors may measure distances of objects sensed in various directions around the vehicle 10. In order to determine a direction (e.g., an angular position, etc.) in which the object was sensed at a distance away from the vehicle 10, multiple ultrasonic sensors may be used (e.g., overlapping, etc.). The multiple ultrasonic sensors may communicate to triangulate the location of the object and thereby determine the distance and position of the object relative to the vehicle 10. For example, the multiple ultrasonic sensors may each measure a distance of an object from the vehicle 10 and transmit the distance to the control system 100 or another computing device, which may mathematically calculate a location of the object, including a direction of the object.

The long-range sensors 802 may have a longer range or larger field of view than the short-range sensors 800 and may be able to detect objects at further distances from the vehicle 10 than the short-range sensors 800. As shown in FIG. 9, two of the long-range sensors 802 are positioned on opposite corners of the vehicle 10. For example, as seen from a top view, one of the long-range sensors 802 may be positioned on a front left corner of the vehicle 10, and another one of the long-range sensors 802 may be positioned on a rear right corner of the vehicle 10. In other embodiments, the long-range sensors 802 may be positioned or oriented differently.

Each corner of the frame 12 defines an angled or chamfered surface 804 extending between (a) the front surface 32 or the rear surface 34 and (b) one of the side surfaces 36. The chamfered surfaces 804 extend at approximately a 45-degree angle relative to the adjacent surfaces. Each of the long-range sensors 802 is coupled to one of the chamfered surfaces 804 by a bracket 806, and the long-range sensor 802 extends below the corresponding bracket 806. By including the chamfered surfaces 804 that are angled relative to the front surface 32, the rear surface 34, and the side surfaces 36, the frame 12 is prevented from obstructing the fields of view of the long-range sensors 802. Accordingly, the chamfered surfaces 804 facilitate full sensor coverage around the vehicle 10 with only two long-range sensors 802.

In some embodiments, the long-range sensors 802 are LIDAR sensors. The LIDAR sensors may use light in the form of a rapidly firing laser (e.g., pulsed, strobed, etc.) to measure distances of objects from the vehicle 10. The light is sent from a source (e.g., a transmitter, etc.) and is reflected by objects. The reflected light is detected by a receiver, and the amount of time taken for the light to travel back to the receiver (e.g., time of flight (TOF), time delay, etc.) is recorded. The reflected light and the recorded amount of time are used to develop a three-dimensional (3D) map of the area surrounding the LIDAR sensor, including any objects present.

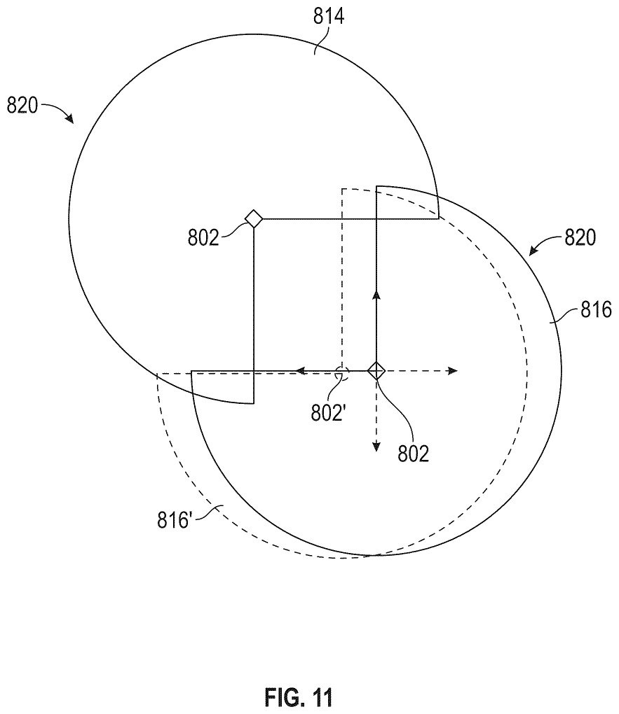

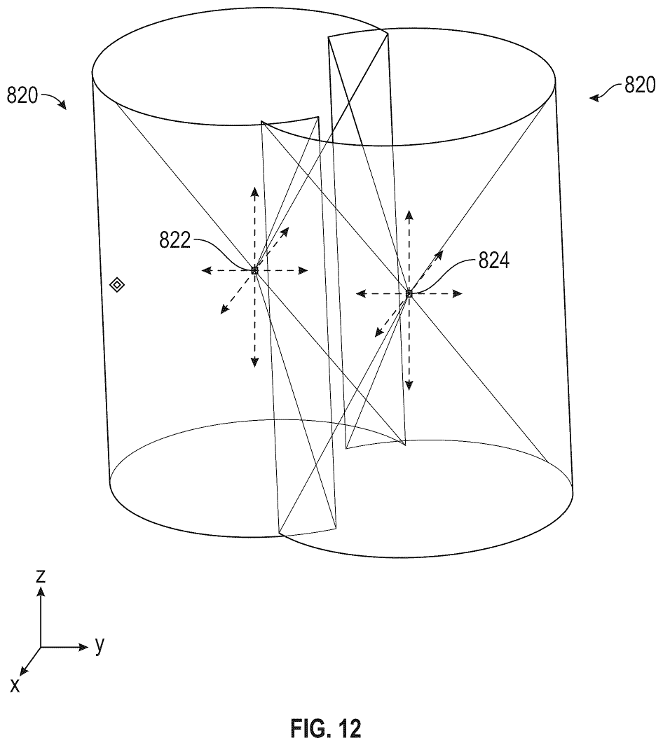

The long-range sensors 802 may generate a point map (e.g., a three-dimensional map of the surroundings) to facilitate navigation of the vehicle 10. In the sensor configuration of FIG. 9, exemplary sensing fields 820 (e.g., fields of view) for the long-range sensors 802 are shown in FIGS. 11 and 12. As depicted in FIG. 11, for which FIG. 12 is a 3D view, each of the long-range sensors 802 may be oriented in opposite directions, substantially symmetrically sensing in opposing directions to cover a 360-degree field of view. For example, one of the long-range sensors 802 may be coupled to the vehicle 10 at point 822 (e.g., a front left corner of the vehicle 10), and another one of the long-range sensors 802 may be coupled to the vehicle at point 824 (e.g., a rear right corner of the vehicle 10). Each of the long-range sensors 802 may have a field of view of approximately 270 degrees as seen from above (e.g., as shown in FIG. 11). For example, the long-range sensor 802 located at the point 822 may have a field of view including the areas in front of the vehicle 10 and to the left side of the vehicle 10. The long-range sensor 802 located at the point 824 may have a field of view including the areas behind the vehicle 10 and to the right side of the vehicle 10. Together, the long-range sensors 802 have a 360-degree field of view in all directions around the vehicle 10.

The long-range sensors 802 may also facilitate locating a position of the vehicle 10 within an environment. For example, the point map generated by the long-range sensors 802 may map the environment surrounding the vehicle 10 and allow the long-range sensors to determine the position of the vehicle 10 within the environment. In another example, the control system 100 may receive a pre-generated map from a remote device 134, and may compare data from the pre-generated map to data gathered by the long-range sensors 802. The comparison of data between the pre-generated map and the long-range sensors may allow the control system 100 to determine the position of the vehicle 10 within the environment.

The sensors 112, including the short-range sensors 800 and the long-range sensors 802, may function to limit operations of the vehicle 10. For example, if the vehicle 10 is stationary and the short-range sensor 800 or the long-range sensor 802 positioned on the front of the vehicle 10 detects an object within the corresponding sensing field, the short-range sensor 800 or the long-range sensor 802 may send a signal to the control system 100 to prevent the vehicle 10 from moving in a forward direction. The vehicle 10 may remain stationary until the object is removed from the path of the vehicle 10. By way of another example, if the vehicle 10 is driving forward and the short-range sensor 800 or the long-range sensor 802 detects an object within the corresponding sensing field, the short-range sensor 800 or the long-range sensor 802 may send a signal to the control system 100 to cease driving operations of the vehicle 10 such that the vehicle 10 comes to a stop. The vehicle 10 may remain at a stop until the object is removed from the path of the vehicle 10, at which time the vehicle 10 may resume motion and proceed forward again.

In general, the short-range sensors 800 are responsible for controlling movement of the vehicle 10 in response to the detection of an object. The long-range sensors 802 are generally responsible for mapping an environment surrounding the vehicle 10 and determining a position of the vehicle 10 in the environment. When the short-range sensors 800 detect an object, the short-range sensors may function to limit operations of the vehicle 10 in various manners. For example, the short-range sensors 800 may stop all movement of the vehicle 10 when an object is detected, or may stop movement of the vehicle 10 only in the direction in which the short-range sensor 800 detected the object. By way of another example, the short-range sensors 800 may function to reduce the speed of the vehicle 10 in response to detecting an object. The short-range sensors 800 may also function to limit or control any other operation of the vehicle 10 such as steering, lifting, etc.

As shown in FIG. 13, the short-range sensors 800 and the long-range sensors 802 may work together in combination with overlapping fields of view to facilitate navigating or driving functions and obstacle avoidance. The long-range sensors 802 may provide a wider field of view, but may experience blind spots at shorter ranges due to a non-zero minimum detection distance. The short-range sensors 800 offer reliable detection capabilities within a short range, and can provide intelligence in the blind spots of the long-range sensors 802.

The vehicle 10 may include a lighting system or other visual or auditory alert system, shown in FIG. 13 as alert system 1406, to provide alerts or information regarding the status of operation of the vehicle 10. For example, during normal operating conditions and while performing a task such as driving, the vehicle 10 may display one or more green lights via the alert system 1406. If there is an object in the path of the vehicle 10, an obstacle obstructing the movement of the vehicle 10, or another condition resulting in halted operation of the vehicle 10, the vehicle 10 may display one or more red lights via the alert system 1406. The vehicle 10 may display other colored lights via the alert system 1406 such as one or more yellow lights, for example, if the vehicle 10 is resuming or about to resume operation after a period of halted operation, or as another example, if the vehicle 10 is proceeding with caution after the removal of the object or obstacle. In some embodiments, the alert system 1406 may be an electronic message board, sounds (e.g., beeping, an alarm, spoken words or phrases, etc.), etc. The alert system 1406 or the vehicle 10 may require a manual reset upon the changing of conditions of operation of the vehicle 10, or any such reset may be performed automatically by the vehicle 10. For example, the one or more lights of the alert system 1406 on the vehicle 10 may turn red upon the detection of an object in the path of the vehicle 10 while the vehicle 10 is driving, and may remain red until the object is removed or the path otherwise becomes clear, at which time the one or more lights on the vehicle 10 may automatically turn green and the vehicle 10 may begin driving again.

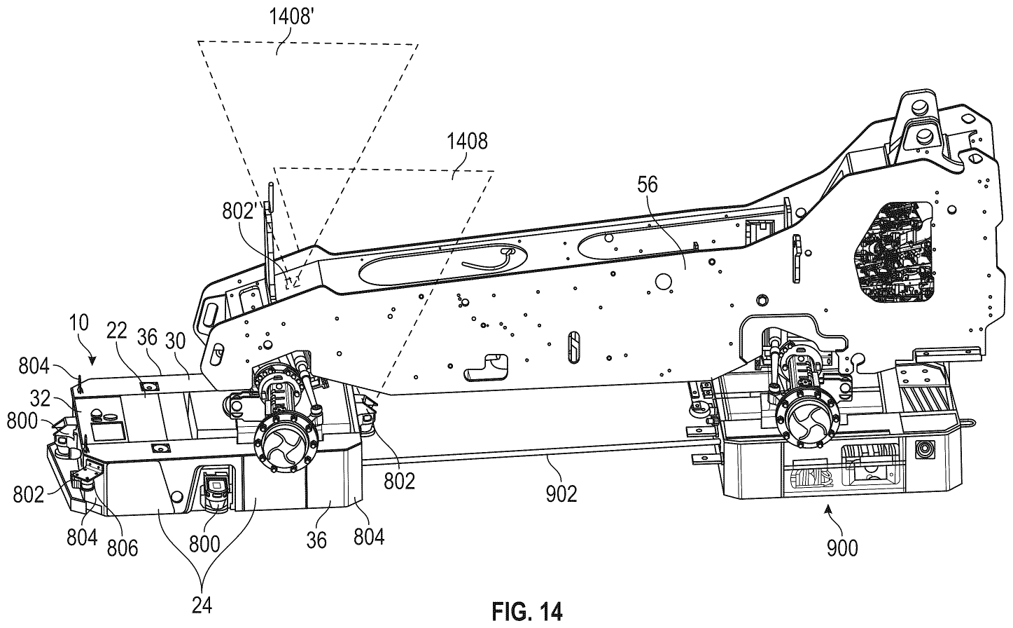

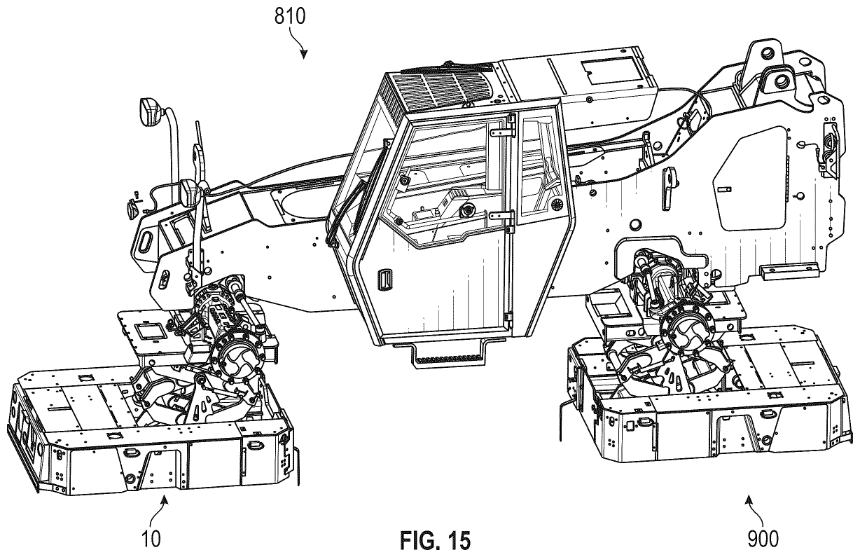

Turning now to FIGS. 14 and 15, in some embodiments, the vehicle 10 may be working in connection with another vehicle 10, or in some embodiments, the vehicle 10 may have a skate 900 coupled to the vehicle 10 by a tow bar 902. The skate 900 may include many of the same features as the vehicle 10, such as the base assembly 48, the lifting implement 50, etc., but may not include other features. For example, the skate 900 may not have the drivetrain 40 and may not possess any means of driving. As another example, the skate 900 may or may not include any of the sensors 112.

The skate 900 may be pulled or towed behind the vehicle 10. As such, the skate 900 may only move in a forward direction. In this respect, an object located behind or to the sides of the skate 900 may not trigger one or more of the sensors 112 to halt operation of the vehicle 10. If an object is present in a location between the vehicle 10 and the skate 900, the short-range sensors 800 and the long-range sensors 802 of the vehicle 10 may detect the object and may halt operation of the vehicle 10, thereby ceasing movement of the skate 900.

The vehicle 10 and the skate 900 may together support a load 810. The load 810 may be a component, a machine, an assembly, a product, a tool, etc. As shown in FIG. 15, the load 810 may be at least partially supported by each of the vehicle 10 and the skate 900. The vehicle 10 and the skate 900 may transport the load 810 between various locations in a production environment.

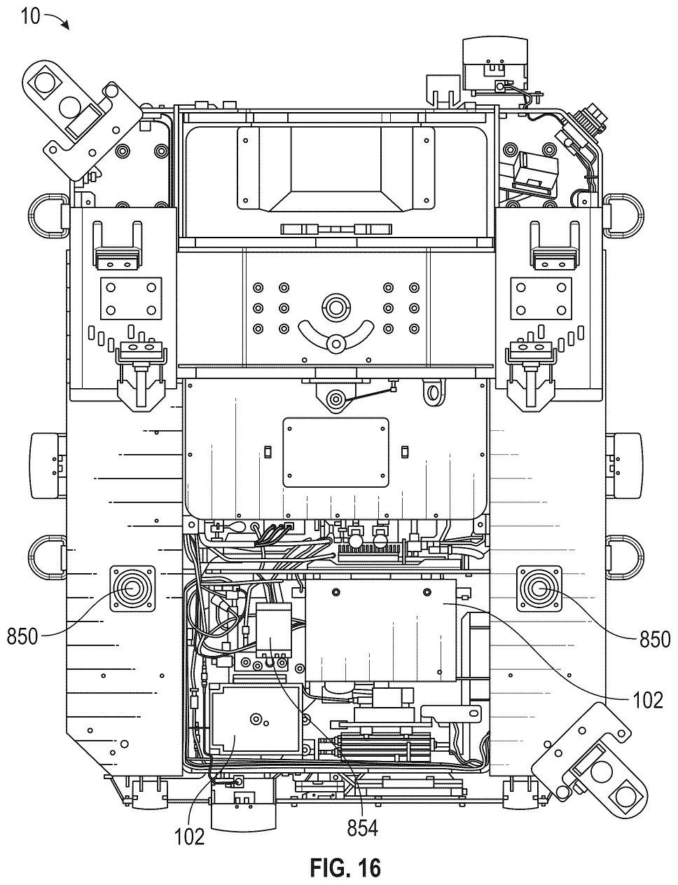

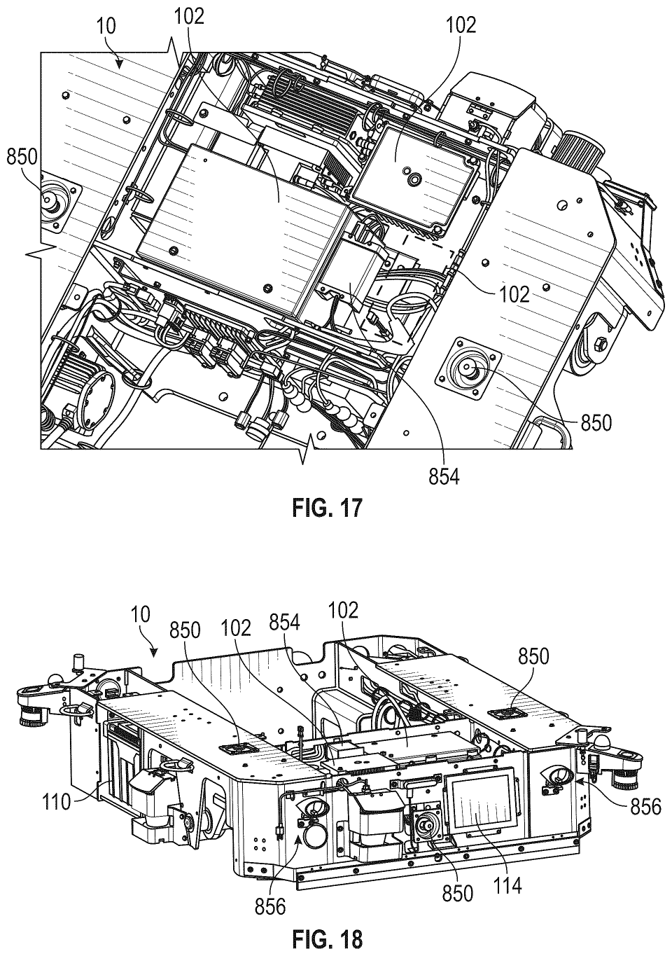

Turning now to FIGS. 16-20, the vehicle 10 as previously described herein is shown according to additional embodiments. The vehicle 10 may include emergency stop buttons 850 as part of user interface 114 which may be pressed by an operator to stop functions of the vehicle 10 in the event of an emergency. As shown in the top view of FIGS. 16 and 17, the vehicle 10 includes the controller 102 coupled to the vehicle 10 within a recess in a top surface of the vehicle 10. The controller 102 may include an autonomy controller, a controller linking the vehicle 10 to the production environment, a hydraulic pump controller, etc. Another device coupled to the vehicle 10 within the recess and/or as part of the controller 102 is an inertial measurement unit 854. A panel may cover the recess to protect the components contained within the recess.

Positioned on a front side of the vehicle 10 may be one or more headlights 856 configured to illuminate the area in front of the vehicle 10. The headlights 856 may also indicate the direction of travel for the vehicle 10. The vehicle 10 also includes a user interface 114 with screen (e.g., a touchscreen, etc.) which may provide information accessible by an operator and may receive input from the operator. Although the user interface 114 is shown on the front side of the vehicle 10, the user interface 114 may be positioned anywhere on the vehicle 10. Additionally, the vehicle 10 may include one or more batteries 110 which may be positioned on a side of the vehicle 10, or anywhere else on the vehicle 10. The batteries 110 may be rechargeable or replaceable.

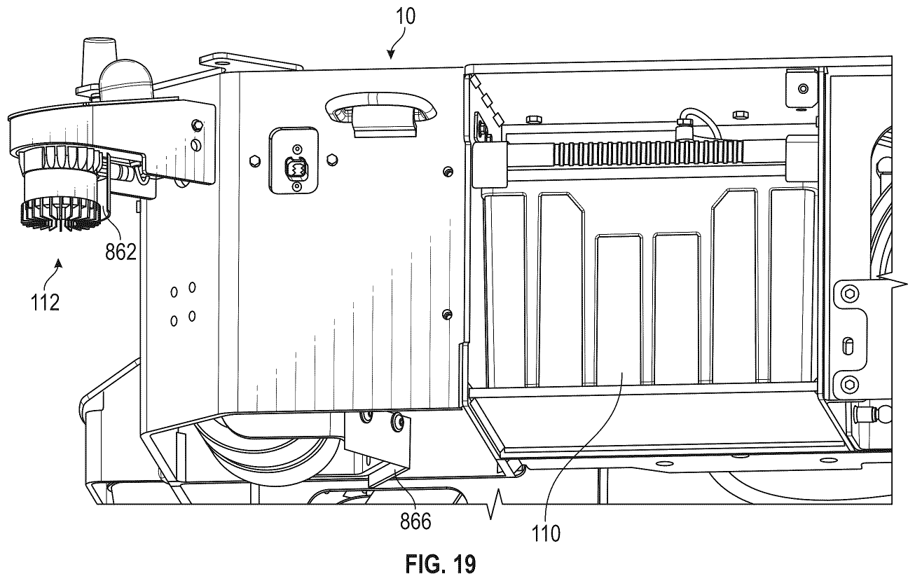

As shown in FIG. 19, the vehicle 10 may include one of the sensors 112 positioned near the front of the vehicle 10. In the example as shown in FIG. 19, the sensor 112 may be a LIDAR sensor. Positioned behind the sensor 112 may be a shield 862. The shield 862 may be, for example, a reflective shield that prevents the sensor 112 from detecting the body of the vehicle 10.

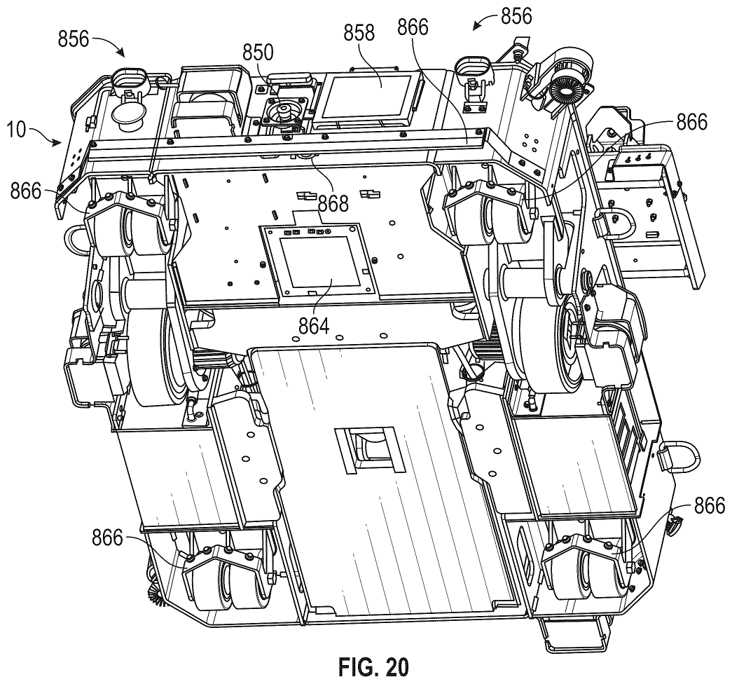

FIG. 20 depicts a bottom view of the vehicle 10, including a wireless charging pad 864. In some embodiments, the vehicle 10 may be able to drive over or be otherwise positioned over the wireless charging pad 864 for easy recharging. Also positioned on the bottom of the vehicle 10 are one or more wipers 866 (e.g., brushes, sweepers, etc.). The wipers 866 may be positioned generally in front of the vehicle 10 and in front of the tractive elements of the vehicle 10. The wipers 866 may be in contact with the ground and may be configured to push debris out of the way of the vehicle 10. Additionally positioned on or near a bottom side of the vehicle 10 may be a ground speed sensor 868 (e.g., a light sensor, etc.). The ground speed sensor 868 may be configured to point towards the ground and send light towards the ground and back, measuring a distance of how far the vehicle 10 has traveled.

A method of operating the vehicle 10 and the system described herein may include several processes. For example, the method may include coupling a sensor system to an autonomous vehicle comprising a base assembly and one or more tractive elements and positioning the autonomous vehicle in an environment. The method may also include driving the vehicle along a path. Additionally, the method may include detecting, by the sensor system, one or more objects located in an area near the autonomous vehicle, and communicating the detection of the one or more objects to a control system. The method may further include generating one or more controls for one or more of the base assembly or the one or more tractive elements and sending the one or more controls to the one or more of the base assembly or the one or more tractive elements. Generating the one or more controls may include generating a stop control. Detecting the one or more objects may include detecting an obstacle or a person.

The method may include additional processes such as coupling a lift assembly to the autonomous vehicle, generating one or more controls for the lift assembly, and sending the one or more controls to the lift assembly. Coupling the sensor system to the autonomous vehicle may include coupling short-range sensors and long-range sensors to the autonomous vehicle. The method may also include generating, by the long-range sensors, a point map mapping an environment surrounding the autonomous vehicle. The method may additionally include receiving, to the control system, a pre-generated map of the environment and comparing, by the control system the pre-generated map to the point map.

### Adjustable Sensor System

As the vehicle 10 facilitates movement of a load (e.g., a product or components of a product, etc.) throughout a manufacturing environment, changes during the movement or changes in the state or configuration of the product may cause one or more of the sensors 112 (e.g., the short-range sensors 800, the long-range sensors 802, etc.) to become obstructed. For example, the vehicle 10 may be facilitating movement of a product during various stages of assembly. As such, the specifications of the product may change during the various stages of assembly. Certain components of the product may therefore be positioned differently on the vehicle 10 at different points in time and may cause an obstruction to the sensors 112. For example, a piece of machinery having a boom may be undergoing assembly. When the boom is added to the assembly during the production of the machinery, the boom may overhang the vehicle 10 or otherwise be positioned to cause an obstruction to a field of view or sensor range of one or more of the sensors 112 (e.g., the booms hangs in front of an ultrasonic sensor on the vehicle 10, etc.).

To account for obstruction of the sensors 112, the vehicle 10 may detect the obstruction and automatically perform a corrective action from a plurality of corrective actions to compensate for the obstruction. The corrective action may include repositioning the sensors 112, activating additional sensors 112, deactivating the obstructed sensors 112, ignoring the signals from the obstructed sensors 112, adjusting a parameter or output of the sensors 112, or other coupling a new sensor 112 to the vehicle 10 and/or the product. The corrective action (repositioning of the sensors 112 on the vehicle 10 or adding additional sensors 112 to the vehicle 10, etc.) may occur automatically in response to an obstruction of one or more of the sensors 112 or it may occur on a certain interval (e.g., when the vehicle 10 reaches a certain station or stage of assembly, etc.).

In some embodiments, the corrective action includes the one or more of the sensors 112 being repositioned or added to the vehicle 10 manually. In such embodiments, the corrective action may include providing a notification to a user indicating the obstruction and what sensors 112 should be moved or added to the vehicle 10. For example, one or more of the sensors 112 may detect an obstruction of one or more of the sensors 112. In response, the controller 102 may submit a request to an operator (e.g., a manager, a user, etc.) to manually reposition one or more of the sensors 112 or add an additional sensor 112 to the vehicle 10. In another example, an operator may detect an obstruction of one or more of the sensors 112. The operator may manually reposition one or more of the sensors 112 or add an additional sensor 112 to the vehicle 10. The operator may reposition or add one or more of the sensors 112 from an offline state on the vehicle 10. The operator may cause the offline sensor 112 to become online, thereby adding the newly online sensor 112 to the sensing system of the vehicle 10. The newly online sensor 112 may remain in place or the operator may reposition the newly online sensor 112 to a different position on the vehicle 10. In some embodiments, the operator may add an additional sensor 112 not already located on the vehicle 10. For example, the operator may have access to a stock of additional sensors 112 that can be added (e.g., coupled, etc.) to the vehicle 10.

In some embodiments, the sensors 112 may be repositioned or moved on the vehicle 10 automatically (e.g., via an actuator, etc.) as the corrective action. Referring back to FIGS. 9-12, the sensors 112, 800, and/or 802 are shown coupled to the one or more tracks, rails, guides, channels, etc. shown as tracks 1402. The tracks 1402 allow the sensors 112 (e.g., sensor 800, 802) to translate along the tracks and move between a plurality of positions relative to the vehicle 10. In some embodiments, the plurality of positions are predetermined positions. In some embodiments, the sensors 112 can move to any position along the track 1402 as determined by the signal from the respective sensor 112. Additionally coupled to one or more of the sensors 112 are actuators, motors, etc. shown as sensor actuators 1404. The sensor actuators 1404 are coupled to the controller 102 of the vehicle 10 and controllable therefrom. Each of the sensor actuators 1404 control a position of the corresponding sensor 112 on the tracks 1402. The sensor actuators 1404 may move the sensors 112 in any of the x, y, or z directions relative to the vehicle 10. For example, there may be a set of vertical tracks slidably coupled to the lateral tracks 1402, with the sensors 112 coupled to the vertical tracks such that the sensors 112 can move both in the horizontal and vertical directions. In some embodiments, the sensors 112 may additionally and/or alternatively be configured to extend and retract towards and away from a center of the vehicle 10. The vehicle 10 also includes secondary sensors 812 for monitoring the positions of the movable primary sensors 112 (e.g., sensors 800, 802). In some embodiments, the controller 102 controls the actuators 1404 based on signal from the secondary sensors 812 indicating the position of the primary sensors 112. In some embodiments, the position of the sensors 112 is inferred from the sensor actuator 1404 position.

In operation, one or more of the sensors 112 may detect an obstruction of one or more of the sensors 112. In response, the controller 102 may automatically control the corresponding sensor actuator 1404 to move the obstructed sensor 112 to a different position (e.g., an unobstructed position on the vehicle 10, etc.). The control 102 may rely on the secondary sensors 812 to determine the position of the obstructed sensors 112 and to monitor the movement of the obstructed sensor 112 to its new position. In some embodiments, the controller 102 is configured to move the sensors 112 through a range of positions until a signal from the sensor 112 indicates the field of view of the sensor 112 is either not obstructed or is obstructed below a threshold amount such that the sensor 112 can operate accurately.

Referring specifically to FIG. 11, the field of views 814 and 816 for two sensors 802 are shown. As described above, in cases where in the sensor 802 is obstructed in some way, the sensors 802 can be moved to a new position, represented by sensors 802′. With the new position, the sensors 802′ also has a new field of view, shown as FOV 816′. Referring now to FIG. 12, the sensors at points 822 and 824 may be repositioned in one or more of the x, y, and z directions to adjust the positions of the sensing fields 820.

Referring again to FIGS. 9-14, in some embodiments, the vehicle 10 may have one or more of the sensors 112 which are located on the vehicle 10 but are in an offline or deactivated state. The controller 102 may cause the offline sensor 112 to become online, thereby adding the newly online sensor 112 to the sensing system of the vehicle 10. The newly online sensor 112 may remain in place or may be repositioned into a different position on the vehicle 10. In some embodiments, the obstructed sensor 112 is brought offline. Beneficially, this can save power and reduce the computational load on the controller 102.

In some embodiments, an additional sensor 112 may be added to the vehicle 10 and/or the product. For example, at a stage of manufacturing where the product extends far longer than the vehicle 10, a sensor 112 can be coupled to a front or end of the product and wirelessly communicate with the controller 102 to provide the controller with accurate information regarding the environment around the vehicle. For example, referring now to FIG. 14, the rear sensor 802 may have a field view 1408 obstructed by the component of the telehandler 56. An additional sensor 802′ can be attached to the component of the telehandler 56 with a field of view 1408′. The additional sensor 802′ is communicably coupled to the vehicle 10, such that the vehicle 10 can deactivate the sensor 802 at the rear of the vehicle 10 and use the sensor 802′ instead. Any one or more additional sensors 112 may be attached to the load (e.g., component 56) via the fixture. The additional one or more sensors 112 may take the place of an obstructed one or more of the sensors 112 or may provide additional sensing in addition to the sensors 112 located on the vehicle 10. Additionally or alternatively, the operator may remove one or more or the sensors 112 from the vehicle 10 and may use the fixture to reattach the one or more sensors 112 to the load (e.g., the operator repositions the one or more sensors 112 from the vehicle to the load via the fixture). Repositioning one or more of the sensors 112 from the vehicle 10 to the fixture attached to the load may provide for a newly unobstructed range of sensing for the one or more repositioned sensors 112. For example, a fixture may be supplied to attach one or more of the sensors 112 to the load. Upon obstruction of one or more of the sensors 112, an operator may use the fixture to attach an additional one or more of the sensors 112 to the load. The fixture may be product-specific for particular loads or may be configured to attach to any type of load. For example, a load may be positioned on the vehicle 10 such that the load extends beyond the chassis (e.g., the frame 12) of the vehicle 10. The fixture may attach one or more of the sensors 112 to a distal end of the load extending beyond the chassis of the vehicle 10.

Any additional sensors 112 added to the vehicle 10 (e.g., added to the vehicle 10, added to a load via a fixture, etc.) may be temporary. For example, an additional sensor 112 may be added to the vehicle 10 or to the load in an advantageous position (e.g., a better position for sensing based on the location of the vehicle 10 or a current task of the vehicle 10, etc.). One or more of the sensors 112 on the vehicle 10 or on the load (e.g., an obstructed sensor, etc.) may be turned off temporarily.

In some embodiments, the controller 102 monitors a state or condition of the product (e.g., manufacturing station, assembly station, assembly state, etc.) and preemptively performs a corrective action to avoid or reduce a predetermined and/or predicted obstruction of a field of view of a sensor. For example, the controller may receive a signal indicating the vehicle 10, and the product it carries, such as boom assembly 68, are prior to a stage wherein the boom assembly 68 will be modified and thereafter obstruct the field of view of a sensor 112. To preemptively account for the upcoming obstruction, the controller 102 may control one or more sensor actuators 1404 to adjust a position of one or more sensors 112 to reduce or eliminate the upcoming obstruction. In some embodiments, the controller 102 includes a plurality of predetermined obstruction states. Each predetermined obstruction state may be associated with the one or more sensors 112 affected by the obstruction, and with positions for the one or more sensors 112 to be moved to accommodate the obstruction. The state or condition of the product can be provided to the vehicle 10 or monitored and/or determined directly via the vehicle 10 by the one or more sensors 112.

In some embodiments, the corrective action includes adjusting a sensor output, signal, or parameter of the sensor 112 based on an obstruction. The parameter or sensor output can be a threshold required to trigger an alert, a threshold require to detect an object, a minimum allowable distance between the vehicle 10 and a detected object, etc. This parameter can be adjusted to accommodate the obstruction. In some embodiments, the corrective action includes the controller 102 ignoring or ‘muting’ the signal from the obstructed sensor 112. For example, if during normal operation (i.e., unobstructed) the sensor 112 may trigger an alert, but the controller 102 has determined the sensors 112 is obstructed (e.g., based on a signal from the sensors 12, a stage or condition of the product, a signal from secondary sensors 812, etc.) the controller 102 can ignore the signal from the obstructed sensor 802 and therefore ‘mute’ the sensor 112.

In some embodiments, the vehicle 10 may have a plurality of operating modes, each corresponding to an arrangement of sensors 112. The plurality of operating modes includes an autonomous mode, a semi-autonomous mode, a manual mode, a slow mode, a fast mode, etc.). For example, if the sensors 112 are in a first position, the controller 102 may control the vehicle 10 in an autonomous mode. If one or more of the sensors 112 are obstructed, the controller 102 may determine the arrangement of the sensors 112 now meets the conditions for a second operation mode such as a semi-autonomous operating mode.

Based on the positioning of the sensors 112 onboard the vehicle 10, a status or confirmation of a status of the sensors 112, or the operating mode, the vehicle 10 may perform various functions. For example, when the sensors 112 are in a first configuration onboard the vehicle 10, the vehicle 10 may be configured to perform certain functions (e.g., only predetermined functions, a first set of steps, etc.). After repositioning of one or more of the sensors 112 or the addition of additional sensors 112, the sensors 112 may be in a second configuration onboard the vehicle 10. In the second configuration, the vehicle 10 may perform certain functions (e.g., only predetermined functions, a second set of steps, etc.) which are different from the functions performed by the vehicle 10 when the sensors 112 are in the first configuration. The vehicle 10 may perform any functions or combination of functions when the sensors 112 are in any configuration onboard the vehicle 10.

The vehicle 10 may also monitor and track the stages of assembly of a product by receiving various inputs (e.g., via the sensors 112, manually by an operator, with a camera, etc.) and processing the inputs. For example, the vehicle 10 may determine a current stage of assembly of the product. The vehicle 10 may then determine an effect on the sensors 112 onboard the vehicle 10 based on the current stage of assembly of the product. The vehicle 10 may determine how the sensors 112 will be affected by one or more stages of assembly of the product and may adjust the sensors 112 accordingly. For example, the vehicle 10 may change the threshold required to trigger a notification or an action. As another example, the vehicle 10 may mute a notification or prevent an action that would be generated by a sensor 112 known to be obstructed at the current stage of assembly of the product.

A method of manufacturing a vehicle according to the description provided herein may include several processes. The method may include providing a frame and coupling an interface assembly configured to support a product to the frame. The method may also include coupling one or more sensors to the frame, the sensors configured to sense an environment around the vehicle. The method may further include communicably coupling a controller to the one or more sensors, the controller configured to receive a signal from the one or more sensors, detect an obstruction in the field of view of the one or more sensors, determine a corrective action to compensate for the obstruction, and automatically perform the corrective action. The controller may be further configured to determine the corrective action by selecting a corrective action from a plurality of corrective actions.

The method may also include one or more additional processes. Configuring the controller to determine the corrective action to compensate for the obstruction may include configuring the controller to reposition one or more of the sensors on the vehicle. The method may include coupling a sensor actuator to one or more of the sensors, the sensor actuator configured to move the sensor between a plurality of positions. Configuring the controller to automatically perform the corrective action may also include moving one or more of the sensors from a first position in the plurality of positions to a second position in the plurality of positions based on the signal, wherein the second position is the position least obstructed according to the signal.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the sensing system as shown in the various exemplary embodiments is illustrative only. Additionally, any element disclosed in one embodiment may be incorporated or utilized with any other embodiment disclosed herein. For example, the sensor configuration of the exemplary embodiment shown in at least FIG. 13 may be incorporated in the vehicle of the exemplary embodiment shown in at least FIG. 9. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An autonomous vehicle system, comprising:
a vehicle;
a sensor movably coupled with the vehicle;
an actuator configured to move the sensor to reposition the sensor on the vehicle; and
a controller configured to detect an obstruction of the sensor and operate the actuator to reposition the sensor.

2. The autonomous vehicle system of claim 1, wherein the controller is configured to operate the actuator to reposition the sensor on the vehicle to an unobstructed location.

3. The autonomous vehicle system of claim 1, wherein the sensor is movably coupled with the vehicle by a track, the actuator configured to move the sensor along the track to reposition the sensor.

4. The autonomous vehicle system of claim 3, wherein the track is a first track extending in a first direction and the actuator is a first actuator, the autonomous vehicle system further comprising a second track extending in a second direction and a second actuator, wherein the controller is configured to operate the first actuator and the second actuator to reposition the sensor in the first direction and the second direction to an unobstructed location.

5. The autonomous vehicle system of claim 1, wherein the controller is configured to monitor a stage of assembly of a product carried by the vehicle and limit repositioning of the sensor or mute an alarm based on a predetermined obstruction to the sensor during the stage of assembly of the product.

6. The autonomous vehicle system of claim 1, wherein the sensor is a first sensor and the actuator is a first actuator, the autonomous vehicle system further comprising a second sensor movably coupled with the vehicle and a second actuator configured to move the second sensor to reposition the second sensor on the vehicle, wherein the controller is configured to:
operate the first actuator and the second actuator to reposition the first sensor and the second sensor, respectively, into a first configuration for a first function of the vehicle; and
operate the first actuator and the second actuator to reposition the first sensor and the second sensor, respectively, into a second configuration for a second function of the vehicle.

7. A vehicle, comprising:
a frame;
an interface assembly configured to support a product;
a sensor coupled to the frame and configured to sense an environment around the vehicle; and
a controller communicably coupled to the sensor, wherein the controller is configured to:
receive a signal from the sensor;
detect an obstruction in a field of view of the sensor based on the signal;
determine a corrective action to compensate for the obstruction; and
control an actuator or adjust operation of the sensor to perform the corrective action.

8. The vehicle of claim 7, wherein the controller is configured to determine the corrective action by selecting the corrective action from a plurality of corrective actions, the plurality of corrective actions comprising at least one of operating the actuator to reposition the sensor, adjusting a threshold value for the signal, ignoring the signal from the sensor, deactivating the sensor, or activating a second sensor.

9. The vehicle of claim 7, wherein the sensor is movably coupled with the vehicle via a track, wherein the actuator is configured to move the sensor along the track.

10. The vehicle of claim 7, further comprising:
the actuator coupled to the sensor, the actuator configured to move the sensor between a first position and a second position,
wherein the corrective action further comprises moving the sensor from the first position to the second position.

11. The vehicle of claim 7, further comprising:
the actuator coupled to the sensor, the actuator configured to move the sensor between a plurality of positions,
wherein the corrective action further comprises moving the sensor from a first position in the plurality of positions to a second position in the plurality of positions based on the signal, wherein the second position is a position that is least obstructed according to the signal.

12. The vehicle of claim 7, wherein the sensor is a first sensor, the vehicle further comprising:
a second sensor configured to sense the environment around the vehicle, wherein the second sensor has a different field of view than the first sensor,
wherein the corrective action comprises:
deactivating the first sensor; and
activating the second sensor.

13. The vehicle of claim 7, wherein the sensor is a first sensor, the vehicle further comprising:
a second sensor coupled to the frame, wherein the second sensor is configured to monitor a position of the first sensor,
wherein the corrective action comprises moving, via the actuator coupled to the first sensor, the first sensor from a first position to a second position based at least partly on a second signal from the second sensor indicating a position of the first sensor.

14. The vehicle of claim 7, wherein the controller is further configured to:
determine a state of assembly of the product; and
determine the corrective action based on the state of assembly of the product.

15. The vehicle of claim 14, wherein the state of assembly of the product is a manufacturing state in an assembly line, and wherein the state is a first state prior to a second state wherein the product would obstruct a field of view of the sensor.

16. A method of manufacturing a vehicle, the method comprising:
providing a frame;
coupling an interface assembly configured to support a product to the frame;
coupling a sensor to the frame, the sensor configured to sense an environment around the vehicle; and
communicably coupling a controller to the sensor, the controller configured to:
receive a signal from the sensor;
detect an obstruction in a field of view of the sensor based on the signal;
determine a corrective action to compensate for the obstruction; and
control an actuator or adjust operation of the sensor to perform the corrective action.

17. The method of claim 16, wherein configuring the controller to determine the corrective action to compensate for the obstruction includes configuring the controller to reposition the sensor on the vehicle.

18. The method of claim 16, wherein the controller is further configured to determine the corrective action by selecting a corrective action from a plurality of corrective actions.

19. The method of claim 16, further comprising coupling a sensor actuator to the sensor, the sensor actuator configured to move the sensor between a plurality of positions.

20. The method of claim 19, wherein configuring the controller to control the actuator or adjust operation of the sensor to perform the corrective action includes moving the sensor from a first position in the plurality of positions to a second position in the plurality of positions based on the signal, wherein the second position is the position least obstructed according to the signal.
